(19) United States
(12) Patent Application Publication
(10) Pub. No.: US 2001/0044705 A1
(43) Pub. Date: Nov. 22, 2001

(54) Method of normalizing software usage data from mainframe computers

(75) Inventors: David Vardi, New York, NY (US); Robert Barritz, New York, NY (US); Peter Kassan, New York, NY (US); Gerald Cohen, New York, NY (US)

Correspondence Address: OSTROLENK FABER GERB & SOFFEN, 1180 AVENUE OF THE AMERICAS, NEW YORK, NY, 100368403

(73) Assignee: Isogon Corp.

(21) Appl. No.: 09/757,257

(22) Filed: Jan. 9, 2001

Related U.S. Application Data
(60) Provisional application No. 60/188,380, filed on Mar. 10, 2000.

(51) Int. Cl. G06F 11/30; G06F 15/00

(52) U.S. Cl. 702/186; 702/182

(57) ABSTRACT

A system and method for monitoring and reporting on the usage of software programs on a computer system interfaces with other systems that measure the computer system performance parameters over time. The system integrates the information for both systems to provide software usage reporting that is normalized to a computer performance criteria or index. Optionally, the restated results are fed back to the software usage reporter, to enable obtaining the results of the methodology of the invention from existing computer software usage reporting programs.

### RELATED APPLICATION

This Application claims priority and is entitled to the filing date of U.S. Provisional Application Ser. No. 60/188,380 filed Mar. 10, 2000, and entitled “METHOD OF NORMALIZING SOFTWARE USAGE DATA FROM MAINFRAME COMPUTERS,” the contents of the provisional patent application are incorporated by reference herein.

### BACKGROUND OF THE INVENTION

In the area of computing, the performance of software is highly dependent upon the performance (i.e., speed) of the hardware. Common benchmarks for hardware performance are usually stated in terms of drystones, whetstones, Millions of Instructions Per Second (MIPS), Million Service Units (MSU), etc. The values derived are highly influenced by various factors including the processor, memory size and speed, cache memory, hardware peripherals, bus speed, operating system, etc.

Thus, for a given computer system, the typical method for comparing the usage of one or more software products is usually established relative to that configuration. Hence, a usage factor obtained for a software product on one computer system, all other conditions being equal, may be dramatically different when run on a different computer system. For example, a product taking 100 CPU-seconds on a 300 MIPS processor may use only 75 on a 400 MIPS system for the very same processing task.

XSLM-compliant licensing systems collect and record data about the usage of the licensed products and relevant events related to license management. Other products, such as SoftAudit from Isogon and FlexLM from Globetrotter, collect usage data, provide usage statistics, and produce reports. None of these systems and products provides a means for the user to compare usage in a dynamically changing environment.

LicensePower/MVS from Isogon provides the user with the ability to “scale” usage statistics however, such measurements are for static configurations. The user must manually select the time intervals of choice (hour, day, week, or month) and the appropriate scale factors that are to be applied for each computer system.

For the most part, products that collect and report usage statistics do so for static configurations and other products that report on environmental changes (of the computing system) do so independently of one another. This is illustrated in prior art FIG. 1.

System 10 is the usage data auditing and collection system, Isogon's SoftAudit product being an example thereof. The system 10 is juxtaposed to the system 30 in FIG. 1 which is used for measuring the capacity of a computer over time. The typical software usage monitoring system includes a first facility 12 which collects software usage data and stores it in a usage log 14. The block 16 extracts usage data and stores software product usage in a log 18. The block 20 generates various reports on software product usage.

In the system 30, the first software block 32 waits for changes in capacity to occur. As changes occur, they are detected and indications thereof are noted as “events” which are stored at step 34 in event log 36. A capacity report is then produced by the capacity report generator 38, which defines how and when the capacity (i.e., performance characteristics of the computer) has changed over selected time periods. In the prior art, the outputs and functionalities of the systems 10 and 30 have not been interfaced or correlated with one another.

Thus, in an environment where computer systems are partitioned (i.e., S/390 LPARs or contain multiple processors) and the capacity and number of the different partitions within these system can be dynamically changed as processing needs change, the measurement and comparison of software usage and licensing fees (which are often based on the computing capacity of the computer on which the software will run) may become skewed as these changes in computing capacities occur.

### SUMMARY OF THE INVENTION

Accordingly, it is an object of the present invention to provide a means of extracting data regarding the change in computing capacity from various information logs; to generate output records of this data; to provide this data to other programs; and to perform various statistical and normalization calculations and report the results.

It is another object of the present invention to combine computing capacity data with software usage data produced by other programs; to generate output records of this combined data; to perform calculations that normalize the usage data; to provide this data to other programs; and to perform various statistical and normalization calculations and report the results.

It is yet another object of the present invention to generate output data records in a format that is compatible with the reporting programs of the products that produced the original software usage data so that they may be used to produce reports using normalized usage data.

The aforementioned and other objects of the invention are realized by an aggregation of software programs which carry out a variety of tasks that obtain results that are usable both independently and in combination. Thus, the present invention employs a first software program which runs substantially continuously on a computer and which monitors and records data that provides a measure of the capacity of the computer over specified time periods. This information is useful by itself or as input to other programs that perform various statistical and normalization calculations on the results.

In a further developed construction of the invention, the results obtained by the first software program are provided to a software program usage monitor that gathers information about the usage of software products on the computer, the results of both programs being combined and normalized to restate software program usage data in a manner that reflects changes in computer capacity over time. As an option, the restated usage data is cast in a form and format that is compatible with the existing format of the software program usage reports.

Other features and advantages of the present invention will become apparent from the following description of the invention which refers to the accompanying drawings.

### BRIEF DESCRIPTION OF THE DRAWINGS

FIG. 1 is a block diagram of software product usage monitoring and computer capacity tracking programs.

FIG. 2 is a flow chart illustrating the normalization of computer product usage data relative to computer capacity event data.

### DETAILED DESCRIPTION OF EMBODIMENTS OF THE INVENTION

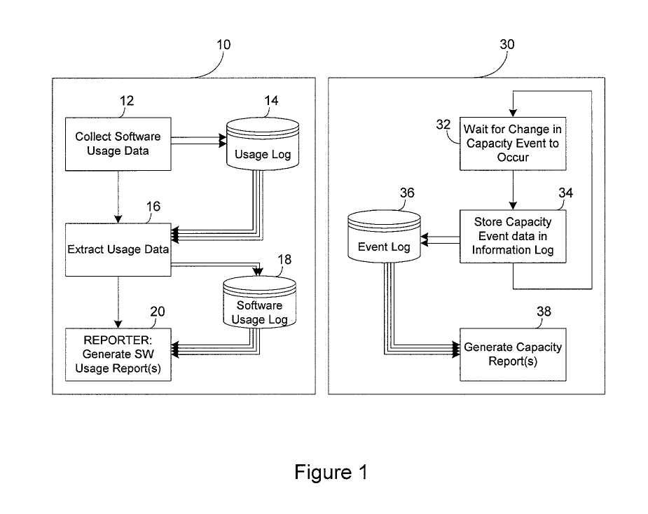

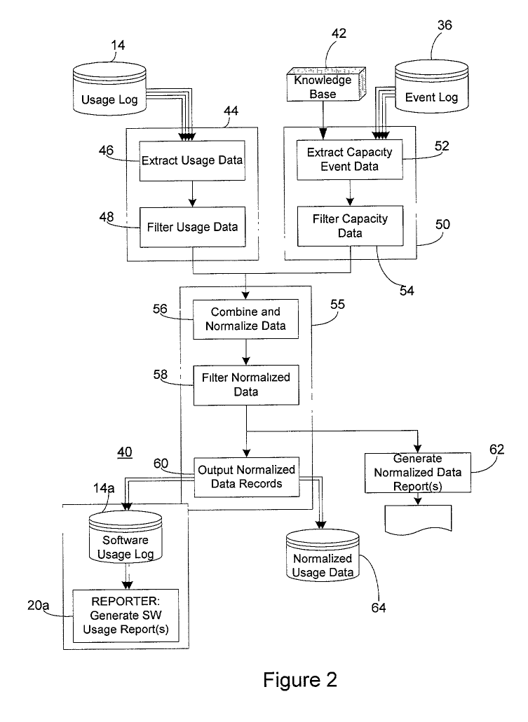

Hereinafter, the term “computing index” or “CI” means or represents a measure of the processing power of a computer or CPU. Typical computing indices are a combination of one or more of MIPS, MSUs, CPU speed, number of processors, drystones, whetstones, Model Group or other such indices. The description below refers at times to software elements that are identified by the numerals appearing in FIGS. 1 and 2.

The licensing fees charged by vendors for software used by large data centers is most often based upon the size of the CPU that the software is run on. Users are either charged a fixed amount according to which of their CPUs fall into a particular class (more commonly known as a “model group”) or, they are charged according to the speed (MIPS rating) of a specific CPU. There is no common basis or standard definition of a model group. Each vendor may establish his own model group pricing schedules separate and apart from what other vendors may use. For example, ABC Corp. may list seven processor groups for software product covering all HAL processors and another company may define twenty groups for those same processors.

The present invention consists of a number of components that can be assembled in building-block fashion such as a single program containing the functionality of one or more of the components; as separate programs that are independently executed; as a program that executes as the result of an API (Application Program Interface) call from one of the other components; as an exit routine from another component; or as combinations of the above.

Knowledge Base (KB):

The KB 42 is a list or database that correlates various computing indices according to any of CPU, CPU to Manufacturer, Vendor to Vendor's Model Group, etc. For example, if an information log lists the CPU as being a HAL-1000, the KB entry for that CPU will contain the appropriate CI for that model and other relevant information. Table 1 is a sample of what information might be contained in the KB.

For example, as demonstrated by the presence of values for MIPS, et al. or other means (not shown), the HAL-1000 CPU is manufactured by the HAL Computer Corp. and is designated as belonging to their Model Group A. Two other vendors, ABC Corp. and XYZ Software designate the same CPU as belonging to their Model Groups C and D, respectively.

Access to information in the KB 42 database can be made directly or, for example, through an API call to a process that first extracts and then returns the appropriate information. In the latter case, various types of API calls can be made that if supplied, for example, with the CPU model number, return the CI in MIPS; the model group applicable to the supplied CPU; etc.

TABLE 1
Sample Knowledge Base

| | | | | | Model |
|---|---|---|---|---|---|
| CPU | MIPS | MSU | LPAR | Manufacturer | Group |
| HAL-1000 | 150 | 175 | 1 | HAL Computer | A |
| | | | | Corp. | |
| HAL-1000 | | | | ABC Corp. | C |
| HAL-1000 | | | | XYZ Software | D |
| HAL-2000 | 210 | 260 | 1 | HAL Computer | C |
| | | | | Corp. | |
| HAL-2000 | | | | ABC Corp. | E |
| HAL-2000 | | | | XYZ Software | H |
| HAL-9000 | 20000 | 35000 | 64 | HAL Computer | S |
| | | | | Corp. | |

Capacity Data Extractor (CE):

The CE 30 (FIG. 1) is a facility which extracts information regarding changes in computing capacity that has been separately gathered and recorded in information logs by a monitoring program, the operating system, Technical License Managers (TLMs) and other programs as appropriate. The information logs may contain specific fields for capacity information, a sequential stream of text messages, or other known formats. Using heuristics and other techniques, the CE 30 interprets these messages and fields to extract the appropriate information. The CE 30 will, according to user-specified parameters:

apply a filter to the capacity information data;

returns a CI or other such capacity information that corresponds to the earliest extracted event, e.g., the MIPS value that was in effect for the very first extracted event;

optionally uses the knowledge base 42 to lookup and substitute the appropriate CI for the CPU model or other identifying data extracted from the information logs;

performs user-specified calculations and outputs data records of those calculations;

outputs data records of (raw) computing capacity event data

Furthermore, the user can provide extraction (filter) specifications such as:

a particular computer system, CPU or LPAR;

a particular location or enterprise;

a period of time

Optionally, the CE 30:

extracts and returns or stores data in response to an API call from another process

extracts and processes data as a exit routine from another process

stores output data in a file or database according to a user-specified format such as comma separated variables (CSV), tab separated variables (TSV), plain text, XML, etc.

accesses the information logs of one or more computer systems from a remote location using a communication network or dial-up access.

accesses the information logs from one or more remote computer systems which have been downloaded to the computer system upon which the CE 30 executes.

sends extracted data to another computing facility, for example, a central clearinghouse of such data.

Minimally, each CE output data record contains the timestamp (date and time or at least date) of the event and the new computing index. Optionally, other relevant information that is output includes the identity of the computer system, processor, LPAR, location, software product, etc. If this information is not contained within the information log, the CE 30 provides this using data from other system configuration records or a user-provided configuration list. For example, a minimal record contains only two fields: TIMESTAMP and CI. A more detailed record contains fields such as TIMESTAMP, CI, PRODUCTNAME, USAGE, LPAR, and LOCATION.

When the CE 30 encounters an event in the capacity information log that is not an actual CI, such as CPU model, it substitutes the appropriate computing index to the output record by using the knowledge base (KB) 42 which also correlates various computing indices to CPU, CPUs to model groups, etc. For example, if the information log (see Table 2) reflects that the HAL-1000 has been upgraded to the HAL-2000, the CE 30 looks up in the KB 42 the MIPS computing index of the HAL-2000 which is 210 MIPS and outputs that as an event record in the event log 36.

TABLE 2
Sample Capacity Information Log for a Multi-computer Installation

| Timestamp | System | LPAR | Info |
|---|---|---|---|
| 1/1/99 | Groucho | 1 | HAL-1000 Installed |
| 00:15 | | | |
| 6/15/99 | Groucho | 1 | HAL-2000 Upgrade Completed |
| 15:11 | | | |
| 6/17/99 | Atlas | 1 | IBM 3090/500J De-installed |
| 12:01 | | | |
| 6/20/99 | Groucho | 1 | MIPS increased to 225 |
| 00:53 | | | |
| 6/22/99 | Harpo | 1 | HAL-1000 Installed |
| 11:11 | | | |
| 6/25/99 | Groucho | 1 | MIPS increased to 250 |
| 00:00 | | | |
| 7/1/99 | Groucho | 0 | HAL-9000 Installed |
| 16:12 | | | |

For example, the information stored in a system configuration log (Table 2) may contain information regarding the addition or removal of processors or the change in processing capacity of one or more computer systems, one or more logical partitions within one or more computers, or a network or sysplex of computers. The user may desire to output the raw capacity event data; or produce certain capacity statistics such as average CI, high watermark CI, number of CPUs, etc. each filtered according to user-specified parameters. Such statistics may be given over a user-selected period of time such as, for example, average daily value for each day, monthly high watermark value, average high watermark for each month in the time period, or second-highest average daily value over a period of days.

By way of example, Table 3 is a sample of the CE output data records produced from the information logs in Table 2 for the ABC Corp. on the “Groucho” system for the month of June, 1999. Note that the CE has performed the appropriate substitutions from the KB—provided a first record reflecting the CI in effect at the beginning of the time period, provided the CI in effect for each event, and inserted the appropriate “ABC model group” for each output event. In the latter case, note that the model group information and timestamps are now available to the user to evaluate any change in licensing costs for software from ABC Corp.

TABLE 3
Sample CE Output Records for ABC Corp. on Groucho 6/1/99-6/30/99

| | CI | Model |
|---|---|---|
| Timestamp | (MIPS) | Group |
| 6/1/99 00:00 | 150 | C |
| 6/15/99 15:11 | 210 | E |
| 6/20/99 00:53 | 225 | E |
| 6/25/99 00:00 | 250 | E |

Usage Data Extractor (UE):

The UE 10 (FIG. 1) is a facility which extracts information regarding software product usage that has been separately gathered and recorded by a monitoring program, the operating system, Technical License Managers (TLMs) or other programs as appropriate (e.g., SoftAudit, FlexLM, etc.). A description of a usage data extractor and reporter appears in the present assignee's U.S. Pat. No. 5,590,056, the contents of which are incorporated by reference herein.

The UE 10, under user-control, extracts usage data from one or more independent information logs; optionally:

applying a filter to the usage data;

combining, as appropriate, the usage data from each of the information logs; and/or

generating output records of the raw combined data

The user can provide extraction specifications (filters) such as:

a particular computer system, CPU or LPAR;

a particular location or enterprise;

a particular software product and/or version; or all software products;

a set of software products optionally, of a specific version;

licensed software products;

products by vendor;

a user or group of users; and/or

a period of time

Optionally, the UE 10:

extracts and returns or stores data in response to an API call from another process;

extracts and processes data as an exit routine from another process;

stores output data in a file or database according to a user-specified format such as comma separated variables (CSV), tab separated variables, plain text, XML, etc.;

accesses the usage information logs of one or more computer systems from a remote location using a communication network or dial-up access;

accesses the usage information logs from one or more remote computer systems which have been downloaded to the computer system upon which the UE 10 executes; and/or

sends extracted data to another computing facility, e.g., a central clearinghouse of such data.

Carrying the preceding sample further, the UE 10 is tasked with extracting all usage information for the Groucho system; for the month of June, 1999; on a daily basis; for all software products from ABC Corp. A sample of the results is shown in Table 4.

TABLE 4
Sample UE Output

| | | | | CPU |
|---|---|---|---|---|
| Timestamp | Product | Users | Jobs | seconds |
| 6/1/99 | ABCview | 2 | 14 | 43.3 |
| 6/1/99 | ABCaudit | 1 | 2 | 3219.1 |
| 6/2/99 | ABCaudit | 1 | 1 | 21 |
| 6/16/99 | ABCview | 4 | 23 | 18 |
| 6/29/99 | ABCaudit | 1 | 2 | 1421 |
| 6/29/99 | ABCview | 3 | 27 | 21 |

Data Combiner (DC):

The DC 55 is a facility which first merges capacity event data extracted by the CE 30 with software product usage data that has been extracted by the UE 10 and then performs various calculations (such as normalization) and outputs the data according to user-specifications.

The DC 55 operates on the two types of data by:

combining usage data with computing capacity event data, optionally, generating output records of the raw combined data;

optionally, sorting, correlating, filtering and performing various user-specified calculations and generating output records of those calculations;

optionally, generating output records in the very same format as the software usage reporting program(s) that originally created the usage data with the appropriate usage fields having been replaced by normalized numbers

Optionally, the DC:

storing output data in a file or database according to a user-specified format such as CSV, TSV, plain text, XML, etc.

sending output data to another computing facility, e.g., a central clearinghouse of such data.

As already noted, an optional facility of the DC 55 is to generate output records in a format that is compatible with various software usage reporting programs (such as SoftAudit's REPORTER) that originally created the usage data with the appropriate usage fields having been replaced by normalized numbers. Thus, the normalized usage log can then be used by whatever processes would otherwise have been used by the original usage log. Programs such as REPORTER generate reports by reading usage data from files that have been prepared in a specified format, typically by another program from the same vendor. Under user-control, the DC 55 generates output records in the very same format with the appropriate usage fields having been replaced by normalized numbers. Using the DC generated normalized usage records as input, the reporting program generates reports that reflect normalized statistics. For example, if the CPU-seconds field is replaced by normalized values, the output report presents a uniform measure of software usage.

Normalization:

Various methods are available to the DC 55 and UR 20 for normalizing usage data using a computing index such as processor speed (e.g., MIPS, total MIPS, MSUs, etc.), number of logical partitions (LPARs), LPAR capacity (MIPS, memory size, etc.), number of processors, or other physical characteristics and configuration settings.

For example, if a baseline of 150 MIPS is established for performance and job accounting analysis then, for any processor or LPAR, the normalized number (XCS) of CPU-seconds used by a job is calculated according to the formula:

XCS=CPU-seconds×MIPS/150

Hence, if a job is run in an LPAR having a 150 MIPS capacity one day and, 200 MIPS capacity the next, the normalized usage (XCS) will provide the user with a consistent measure of resource usage.

Other methods of normalization and processing CI and usage data over a period of time include running averages, high watermark usage, user-MIPS (product of current number of users and MIPS), etc.

Optionally, the user may specify a formula to be used in the normalization and output of usage data. The formula can specify how the data in certain DC fields are to be used; various scaling factors such as cost/cpu-second; and how to normalize data for specific instances, e.g., according to a specific LPAR or LOCATION.

Carrying the preceding example further, the DC combines the CE and UE output data, Tables 3 and 4, respectively, and applies the above formula to normalize the CPU-seconds data. The output of the DC (Table 5) is in a format compatible with SoftAudit's REPORTER program. Note that the normalized data is reflected in the last three entries.

TABLE 5
Normalized Output Usage Data

| | | | | Normalize |
|---|---|---|---|---|
| | | | | d CPU |
| Timestamp | Product | Users | Jobs | seconds |
| 6/1/99 | ABCview | 2 | 14 | 43.3 |
| 6/1/99 | ABCaudit | 1 | 2 | 3219.1 |
| 6/2/99 | ABCaudit | 1 | 1 | 21 |
| 6/16/99 | ABCview | 4 | 23 | 25.2 |
| 6/29/99 | ABCaudit | 1 | 2 | 2368.3 |
| 6/29/99 | ABCview | 3 | 27 | 35 |

Usage Reporter (UR):

The UR 20 is a process which uses DC output data to sort, correlate, consolidate, summarize, format and output reports that have normalized usage statistics based upon user-specified parameters and formulae. As the data is read, the UR 20 computes the appropriate usage statistics applying the current capacity index factors. If an event denotes a change in a capacity factor, the UR 20 may note that in the output report and then apply the new capacity factors in its calculations.

For example, the user can specify that the UR 20 generate a report based upon a user-specified Model Group such as a CI in the range of 0-100 MIPS is Model Group A, 100-150 MIPS is Model Group B, etc. Accordingly, minor changes in CI are reported in favor of cumulative changes in capacity that cross from one Model Group factor to another.

For completeness and summary, FIG. 1 illustrates the usage report 10 and its constituent components including a section 12 that collects software usage data and stores the raw information in a usage log 14. The component 16 extracts some of the data, stores it in a software usage log 18 and the reporter 20 generates the standardized reports, as in the prior art exemplified by the U.S. Pat. No. 5,590,056.

The capacity extractor 30 includes the component 32 which waits for a change in capacity to occur and stores at component 34 the event information in an information log and then stores events in an event log 36, using the generator 38 to generate capacity reports.

The functions of the elements 10 and 30 in FIG. 1 are combined in FIG. 2 in a system according to the invention which uses a modified usage extractor 44 that extracts usage data from the usage log 14 as indicated by component 46 and applies various filtering and selection criteria as indicated by component 48.

Simultaneously, the capacity extractor 50 accesses the event log 36 and the knowledge base 42 which contains various correlation data to obtain or extract capacity event data as indicated by element 52. The filter 54 reduces that data which is then combined with data obtained from the usage extractor 44 in the data combiner 55 which includes the component 56 which combines and normalizes data. The component 58 then applies further filtering and the outputer 60 outputs normalized data records to a normalized usage data log 64 as well as to a software usage log 14a. The element 62 can generate separate normalized data reports. However, the same information can be obtained from the software usage log 14a and used by a standard reporter program 20a which generates reports from a conventional usage extractor program 10, such as Isogon's SoftAudit product, which is illustrated in FIG. 1.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of normalizing software usage data that is gathered in relation to the execution of software products on a computer, the method comprising the steps of:
running a first software and determining the capacity of the computer over time and obtaining computer capacity data;
running a second software that determines the usage of the software products on the computer over time; and
correlating usage information obtained by the second software with computer capacity data obtained by the first software in a manner which restates the results of the software usage data based on variations over time of the computer capacity data.

2. The method of claim 1, including basing the correlation on statistical analysis.

3. The method of claim 1, including normalizing the usage data relative to computer capacity.

4. The method of claim 1, including combining the computer capacity data with the usage data.

5. The method of claim 4, including generating a plurality of output reports.

6. The method of claim 4, including restoring combined data into a reporter of the second software so that the second software will operate on the restored data as though it was data which it had generated itself.

7. The method of claim 1, including determining the capacity of the computer over time by developing a computer index representing variations of the computer capacity data over time.

8. The method of claim 1, including running the first and second software as separate software programs.

9. The method of claim 1, including a knowledge base and accessing the knowledge base and deriving from it information to compute the computer capacity data.

10. The method of claim 9, including accessing the knowledge base via an application program interface.

11. The method of claim 7, in which the computer index is calculated as a combination of one or more of a plurality of computer parameters selected from the group consisting of: MIPS, MSUs, CPU speed, number of processors, drystones, whetstones, and Model Groups.

12. The method of claim 9, in which the knowledge base is a database that correlates various computer indices according to a plurality of parameters including CPU, CPU to manufacturer, vendor to vendor's model groups.

13. The method of claim 1, in which the first software develops the computer capacity data from data gathered by other computer programs and the other computer programs are selected from a group consisting of: a monitoring program, an operating system, and a technical license manager.

14. The method of claim 1, in which the first program includes a facility for selecting data concerning the computer capacity data based on a selection criteria comprising one or more of: applying a filter to the computer capacity data; returning a computer index or other capacity information that corresponds to an earliest extracted event; using a knowledge base to determine computer capacity from CPU model data; performing user-specified calculations; and outputting data records of computing capacity event data.

15. The method of claim 1, in which the first program selects capacity information in relation to filter specifications consisting of one or more of: a particular computer system; CPU; LPAR; a particular location or enterprise; and a period of time.

16. The method of claim 1, further including temporally stamping information stored in an event log which contains the computer capacity data.

17. The method of claim 1, further including processing computer capacity data to develop a capacity index comprising one or more of: average computer index, high watermark computer index, and number of CPUs.

18. The method of claim 1, in which the second software extracts information based on extraction specifications comprising one or more of: a particular computer system; CPU; LPAR, a particular location or enterprise; a particular software product; products by vendors; a user or group of users; and a period of time.

19. The method of claim 1, further comprising producing combined data by combining data obtained by the first software and by the second software.

20. The method of claim 19, further including combining usage data with computer capacity event data as combined raw data records.

21. The method of claim 19, further including sorting, correlating, filtering and performing user-specified calculations relative to the combined data.

22. The method of claim 1, further including storing output data in a file or database according to a user-specified format.

23. The method of claim 1, further including sending output data to another computing facility.

24. The method of claim 23, in which the computing facility comprises a central clearing house of such data.
